(19) United States
(12) Patent Application Publication
(10) Pub. No.: US 2005/0265834 A1
(43) Pub. Date: Dec. 1, 2005

(54) Fan structure

(75) Inventors: Jia-Yeh Wang, Chungho City (TW); Chih-Ming Cheng, Tu Cheng City (TW); Ta-Yun Tai, Chungho City (TW); Wen-Sung Li, Chungho City (TW)

Correspondence Address: TROXELL LAW OFFICE PLLC, SUITE 1404, 5205 LEESBURG PIKE, FALLS CHURCH, VA, 22041, US

(73) Assignee: HARVATEK CORPORATION

(21) Appl. No.: 10/855,381

(22) Filed: May 28, 2004

(51) Int. Cl. H02K 11/00

(52) U.S. Cl. 415/220

(57) ABSTRACT

A fan structure of the present invention has a base having a first supporting piece, a motor stator mounted on the base, a motor rotor defined corresponding to the motor stator, a fan blade having a hub located at a central portion thereof, one end of the hub abutting the first supporting piece. The motor rotor is mounted on an inner wall of the fan blade. An upper cover body covers a periphery of the fan blade, the upper cover body has an oblique resilient portion defined on a top portion thereof, the resilient portion defines a second support piece thereon, and the second support piece abuts another end of the hub. The improved fan structure is a bearingless structure, which can simplify the overall structure, is easy to assemble, effectively reduces manufacturing costs and improves a rotating stability of the hub.

### BACKGROUND OF THE INVENTION

1. Field of the Invention

The present invention relates to an improved fan structure, and especially to an improved structure of fan without a bearing.

2. Description of Prior Art

Referring to FIG. 1, a conventional fan structure includes a motor rotor 80 and a motor stator 81, the motor rotor 80 having a fan blade 82 coupled to an exterior thereof, and the fan blade 82 connected with a hub 83 located in a center thereof. The motor stator 81 is in a form of a winding body, which is mounted within the motor rotor 80 and fixed on a base 84. The hub 83 is inserted in a bearing 85 set inside the base 84. The hub 83 is fastened with a ring 86 at the bottom of the bearing 85 so that the fan blade 82 and the hub 83 are formed on the base 84 pivotally, and rotate freely. The motor rotor 80 has a permanent magnet 87 positioned therein; an inner periphery of the permanent magnet 87 is provided corresponding to an outer periphery of the motor stator 81 and an air gap remains therebetween, so as to drive the hub 83 and the fan blade 82 to rotate via magnetic field effect produced by the motor rotor 80 and the motor stator 81.

In the conventional fan structure as described above, the hub 83 is pivotally mounted on the base 84 via the bearing 85. Because the hub 83 and the bearing 85 are coupled together in a surface contact manner, the contact area therebetween is large and causes the bearing 85 to suffer greatly from abrasion. Moreover, heat tends to collect in this are and decreases the lifetime of the bearing.

FIG. 2 shows another conventional fan structure without a bearing. The conventional fan structure without a bearing includes a hollow casing 90 having a base 91, the base 91 having a hollow pillar 92 extending upwardly, a circuit board 93 and a motor stator 94 respectively mounted around a periphery of the hollow pillar 92. The hollow pillar 92 has a lower supporting plate 95 set thereon. The casing 90 is covered with an upper supporting plate 96, and a fan blade 97 is formed in the casing 90. A hub 98 having two round-head ends in acuate shape passes through an center of the fan blade 97 located between the upper supporting plate 96 and the lower supporting plate 95. A motor rotor 99 is attached to the fan blade 97. The motor stator 94 and the motor rotor 99 induce the hub 98 and fan blade 97 to rotate between the upper supporting plate 96 and the lower supporting plate 95 with a magnetic field effect. In the conventional fan structure without a bearing, the hub 98 pivots with a bearingless manner, and is coupled to the upper and lower supporting plates 96, 95 in point contacting manner with a small contact area. Thus, it can reduce abrasion wear and increase the lifetime thereof. Likewise, it is impossible for heat to concentrate in this location and the lifetime of bearing is thus increased.

However, a plurality of clamping members 100 to secure the hub 98 firmly is necessary and is located between the upper supporting plate 96 and the lower supporting plate 95. Each clamping member 100 includes a fixing screw 101 and a pressed spring 102. The fixing screw 101 is embedded in the upper supporting plate 96 and screwed into a mounting holder 103. The pressed spring 102 is positioned between the upper supporting plate 96 and the lower supporting plate 95, and surrounds the fixing screw 101 and offers a elastic force that helps the hub 98 sit stably between the upper supporting plate 96 and the lower supporting plate 95. Unfortunately, utilization of the design of the clamping member 100 causes the overall structure of fan to become more complex and difficult to assemble, making the fan more expensive. Furthermore, the lower end of the hub 98 is located on the lower supporting plate 95, which is set within the hollow pillar 92, and because the hollow pillar 92 is unstable state due to its hollowness, a rotating stability of the hub 98 is poor, and the rotation of the fan blade 97 is unstable. In additional, to be positioned on the lower supporting plate 95, the hub 98 needs to be sufficiently long so as to extend in the hollow pillar 92. This requires more materials and also increases manufacturing costs.

### SUMMARY OF THE INVENTION

An object of the present invention is to provide an improved structure of a fan without a bearing, which reduces wear, does not concentrate heat, increase the lifetime thereof, simplifies the overall structure, is easy to assemble, effectively reduces manufacturing costs, improves rotating stability of the hub and saves material.

To achieve the above object, a fan structure with the improvement of the present invention comprises a base having a first supporting piece, a motor stator mounted on the base, a motor rotor defined corresponding to the motor stator, and a fan blade having a hub located at a central portion thereof. One end of the hub abuts the first supporting piece, and the motor rotor is mounted on an inner wall of the fan blade. An upper cover body covers a periphery of the fan blade, the upper cover body having an oblique resilient portion defined on a top portion thereof. The resilient portion defines a second support piece thereon, and the second support piece abuts another end of the hub.

### BRIEF DESCRIPTION OF THE DRAWINGS

Other objects, advantages, and novel features of the present invention will become more apparent from the following detailed description when taken in conjunction with the accompanying drawings, in which:

FIG. 1 is a cross-sectional view of a conventional structure of fan;

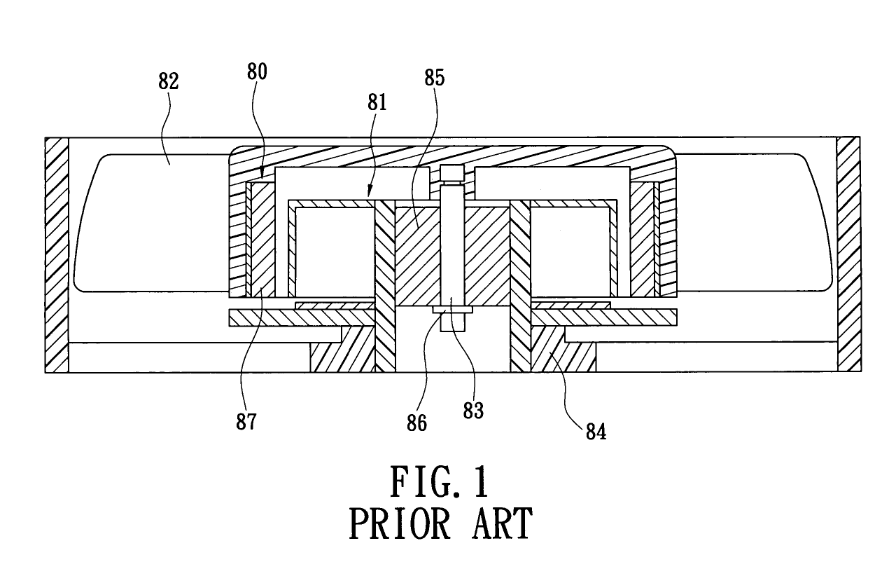

FIG. 2 is a cross-sectional view of another conventional structure of fan;

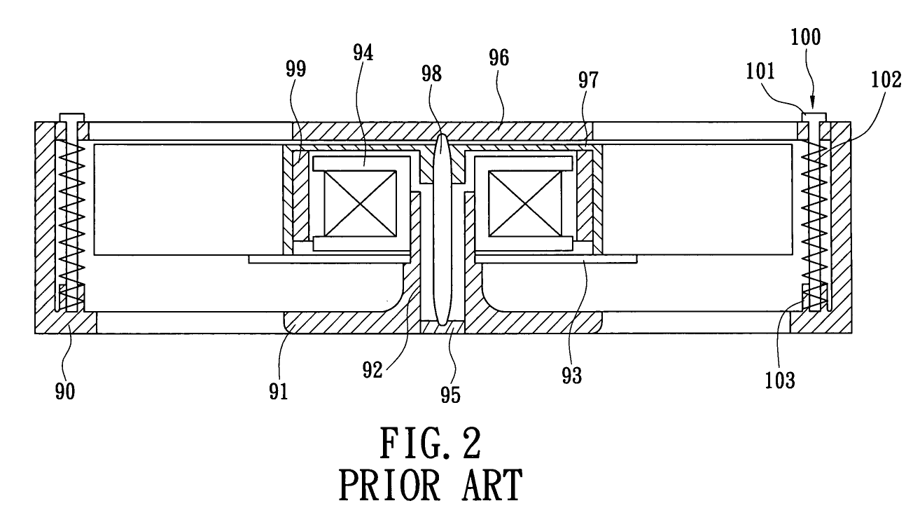

FIG. 3 is an exploded, cross-sectional view of a fan structure according to an embodiment of the present invention;

FIG. 4 is a cross-sectional view of an assembly state of the fan structure shown in FIG. 3; and

FIG. 5 is a cross-sectional view of an assembly state of a fan structure according to another embodiment of the present invention.

### DETAILED DESCRIPTION OF THE INVENTION

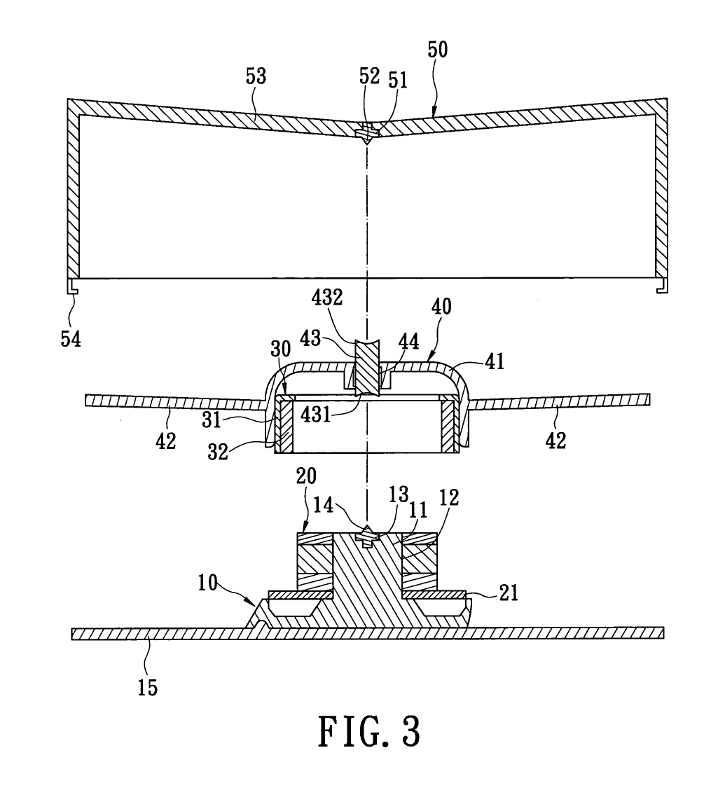

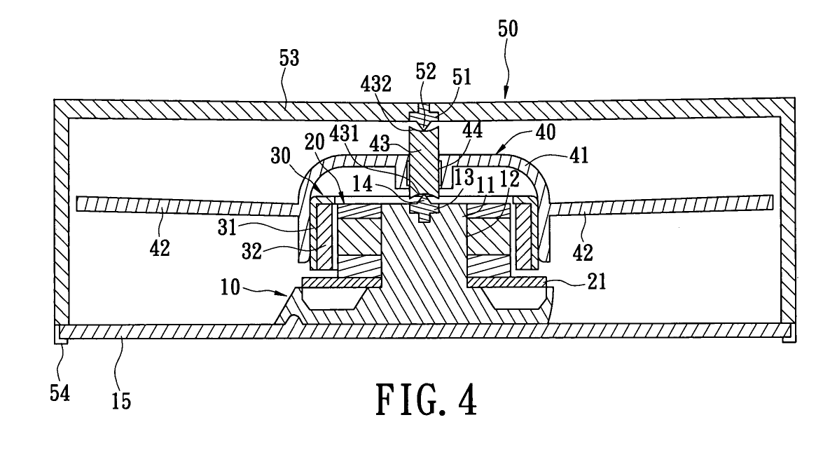

Referring to FIG. 3 and FIG. 4, a fan structure with the improvement according to the present invention comprises a base 10 disposed on a bottom thereof, a motor stator 20, a motor rotor 30, a fan blade 40 and an upper cover 50. The base 10 has an upwardly protruding stator mounting portion 11 with a solid cylindrical shape. The stator mounting portion 11 further includes an outside wall 12 surrounding its periphery.

The stator mounting portion 11 has a first supporting piece 13 securely mounted on a top thereof. The first supporting piece 13 defines a first supporting portion 14, which upwardly protrudes from a top portion thereof and is shapes as an acuate taper. The first supporting piece 13 can be made by metallic or nonmetallic materiel with a preferable wearability. A plate-shaped connecting portion 15 is fastened under the base 10. The connecting portion 15 extends outwards properly for adapting to the upper cover 50 so that the connecting portion 15 can couple to the upper cover 50.

The motor stator 20 is in a form of a winding body, which is positioned surrounding the outside wall 12 of the stator mounting portion 11. The motor stator 20 is properly fixed on the base 10 and a bottom of the motor stator 20 is electrically connected to a circuit board 21; the circuit board 21 is also disposed surrounding the outside wall 12 of the stator mounting portion 11.

The motor rotor 30 includes a frame 31 and a permanent magnet 32 fixed on an inner wall of the frame 31. The frame 31 is mounted on an inner wall of the fan blade 40 by, for example, adhesion. The permanent magnet 32 can thus be securely fixed on the inner surface of the fan blade 40 via the frame 31.

The fan blade 40 includes a housing 41 having a plurality of blades 42 connected to an outside wall thereof. The housing 41 is a hollow cavity with an open bottom. A hub 43 is defined through a center of the housing 41. The hub 43 extends perpendicularly and defines engaging portion 44 having a concave or protruding shape. When the housing 41 is coupled to the hub 43 by injection molding, the engaging portion 44 can firmly couple to the housing 41 to prevent skidding. The hub 43 is a barrel hub made of, for example, a material with a preferable abrasion resistance, such as that made of a ceramic material with a preferable abrasion resistance.

Both an upper end and a lower end of the hub 43 respectively extend out from a top end and a bottom end of the center of housing 41 with a certain proper length. The hub 43 defines a first recessed surface 431 and a second recessed surface 432 in upper and lower ends thereof, respectively. The first recessed surface 431 abuts the first supporting portion 14 of the first supporting piece 14 so as to form a point contact between the lower end of the hub 43 and the first supporting piece 14.

The upper cover 50 is located over the motor stator 20, motor rotor 30 and the fan blade 40. The upper cover 50 includes a plurality of fastening members 54 formed on a bottom thereof. The fastening members 54 are coupled to a corresponding flange of the connecting portion 15 the base 10 to form a closes casing for containing the motor stator 20, motor rotor 30 and fan blade 40 inside.

The upper cover 50 has a top portion, which is inclined from an outside edge toward the center so as to form an oblique resilient portion 53, i.e., the center of the upper cover 50 is set at the lowest location. A second supporting piece 51 is attached to an center of the resilient portion 53, which is made of metal or nonmetal material with a preferable abrasion resistance. The second supporting piece 51 is provided over the fan blade 40 and having a protruding second supporting portion 52 defined on a bottom thereof. The second supporting portion 52 is pressed against the second recessed surface 432 of the upper end of the hub 43 so as to form a point contact between the upper end of the hub 43 and the second supporting portion 52.

After the upper cover 50 and the base 10 are connected together, two ends of the hub 43 can be press-fitted onto the corresponding supporting portion 14, 52 of each supporting piece 13, 51 by utilizing a suitable elastic force offered by the oblique resilient portion 53 of the upper cover 50. With the help of this elastic force, the hub 43 can be located stably between the first supporting piece 13 and the second supporting piece 51.

Thus, the hub 43 of the fan blade 40 can be pivoted and rotated between the base 10 and the upper cover 50 via the supporting portions 52 provided by the supporting piece 51 and the supporting portions 14 provided by the first supporting piece 13, respectively. Furthermore, the housing 41 of the fan blade 40 is formed to cover a periphery of the motor stator 20, an inner periphery of the permanent magnet 32 of the motor rotor is provided corresponding to an outer periphery of the motor stator 20 and an air gap remains therebetween, so as to drive the hub 43 and the fan blade 40 to rotate between two supporting pieces 51, 13 via a magnetic field effect produced by the motor rotor 30 and the motor stator 20.

As mentioned above, the fan structure in accordance with the present invention has several advantages. The hub 43 is pivoted and located between supporting pieces 13, 51 without a bearing and the contact area therebetween is less by point contact. Thus, wear is less and heat is not concentrated, which results in a longer lifetime for the fan.

Moreover, with the elastic force offered by the resilient portion 53, the hub 43 can be located stably between the first supporting piece 13 and the second supporting piece 51, which can greatly simplify the overall structure of the fan, making the fan easy to assemble and cheaper.

In additional, the hub 43 and the fan blade 40 can rotate stably because the stator mounting portion 11 of the base 10 is solid shape with a stronger structure. Furthermore, the length of the hub 43 is shortened compared with conventional structures, which conserves fabrication materials.

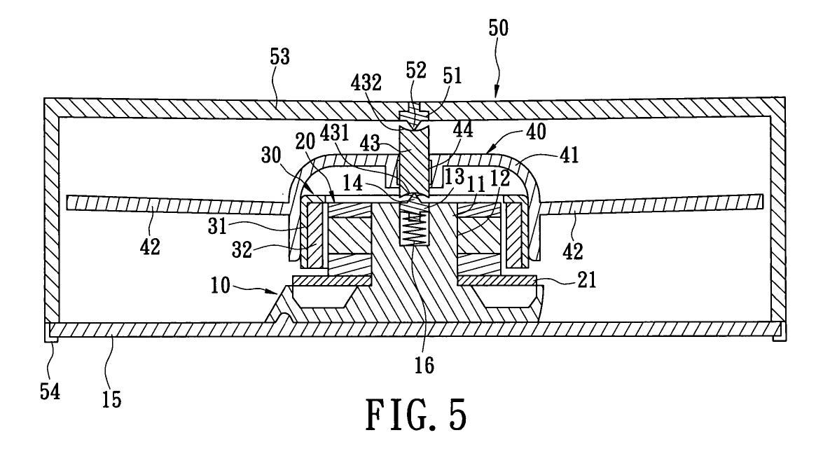

Referring to FIG. 5, the present invention provides an alternative embodiment, which provides a resilient element 16 on the base 10 to offer a pressing elastic force, i.e., providing a resilient element 16 between the first supporting piece 13 and the base 10. The resilient element 16 can force the first supporting piece 13 to press elastically against the lower end of the hub 43, causing the two ends of the hub 43 to be press-fitted onto the corresponding supporting portion 14, 52 of each supporting pieces 13, 51, respectively. Therefore, with the help of this elastic force, the hub 43 can be located stably between the first supporting piece 13 and the second supporting piece 51.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A fan structure comprising:
a base having a first supporting piece;
a motor stator mounted on the base;
a motor rotor defined corresponding to the motor stator;
a fan blade, a central portion of the fan blade having a hub, one end of the hub abutting the first supporting piece, and the motor rotor mounted on an inner wall of the fan blade; and
an upper cover body covering a periphery of the fan blade, a top portion of the upper cover body having an oblique resilient portion, the resilient portion defining a second support piece thereon, another end of the hub abutting the second support piece.

2. The fan structure as described in claim 1, wherein the first supporting piece of the base includes a first supporting portion pressed against the one end of the hub, the second supporting piece includes a second supporting portion pressed against the another end of the hub, and both the first and second supporting portions are acuate cones in shape.

3. The fan structure as described in claim 1, wherein the base has a upwardly protruding stator mounting portion, the stator mounting portion is a solid cylinder, the first supporting piece is mounted on a top of the stator mounting portion, the motor stator is positioned surrounding a periphery of the stator mounting portion, a bottom of the motor stator is connected with a circuit board, and the circuit board is also positioned surrounding the periphery of the stator mounting portion.

4. The fan structure as described in claim 1, wherein the motor rotor includes a frame and a permanent magnet, the permanent magnet is mounted on an inner wall of the frame, and the frame is mounted on the inner wall of the fan blade.

5. The fan structure as described in claim 1, wherein the fan blade includes a housing having a plurality of blades coupled to an outside wall thereof, the hub is defined through a center of the housing, and the hub has a engaging portion coupled to the housing.

6. The fan structure as described in claim 1, wherein the hub provides a first recessed surface in a lower end thereof, the first recessed surface abuts the first supporting piece for forming a point contact between the lower end of the hub and the first supporting piece.

7. The fan structure as described in claim 1, wherein the hub defines a second recessed surface in an upper end thereof, and the second recessed surface abuts the second supporting piece for forming a point contact between the upper end of the hub and the second supporting piece.

8. The fan structure as described in claim 1, wherein the upper cover body includes a plurality of fastening members formed on a bottom thereof, and each fastening member is coupled to a corresponding connecting flange of the base.

9. The fan structure as described in claim 1, wherein the top portion of the upper cover body is inclined from an outside edge toward a center thereof to form the oblique resilient portion, and the second supporting piece is located at a center of the resilient portion.

10. A fan structure, comprising:
a base, having a first supporting piece;
a resilient member positioned between the base and a bottom of the first supporting piece;
a motor stator mounted on the base;
a motor rotor defined corresponding to the motor stator;
a fan blade having a hub located at a center thereof, the first supporting piece being pressed against one end of the hub, and the motor rotor being mounted on an inner wall of the fan blade; and
an upper cover body covering a periphery of the fan blade, the upper cover body defining a second support piece thereon, and the second support piece pressing against another end of the hub.
